(19) United States
(12) Patent Application Publication
(10) Pub. No.: US 2016/0063456 A1
(43) Pub. Date: Mar. 3, 2016

(54) Methods and Apparatuses for Point of Use Consumption of Renewable Energy Credits

(71) Applicant: Paul W. DROEGE, Albuquerque, NM (US)

(72) Inventor: Paul W Droege, Albuquerque, NM (US)

(21) Appl. No.: 14/782,321

(22) PCT Filed: Mar. 11, 2014
(86) PCT No.: PCT/US14/23674

§ 371 Date: Oct. 3, 2015

Related U.S. Application Data
(60) Provisional application No. 61/778,384, filed on Mar. 12, 2013.

(51) Int. Cl. G06Q 20/06; G06Q 30/00; G06Q 20/20

(52) U.S. Cl. CPC G06Q 20/06; G06Q 20/208; G06Q 30/018

(57) ABSTRACT

The present invention provides methods and apparatuses that can establish a correspondence between individual energy consumption and renewable energy resources. The invention can described as comprising two elements combined into an independently verifiable system: (1) a suitably accurate means of tracking or otherwise determining the power consumption of a device or devices of interest; and (2) a third-party auditable, renewable energy credit tracking system that matches (whole or fractional) renewable energy credits to the power consumed by the device or devices. The inventions are described herein in the context of various example embodiments.

This invention is related to the inventions described in U.S. provisional 61/778,382, filed Mar. 12, 2013, which is incorporated herein by reference.

### BACKGROUND

This invention relates to apparatuses facilitating point of use consumption of renewable energy credits, including methods and apparatuses for charging electrically powered vehicles including charging vehicles using renewable energy.

There is widespread interest in use of renewable energy. It is impractical, however, for an individual energy consumer to build and maintain a personal renewable energy generation system. Most electrical power is generated and delivered to a system of electrical transmission called the “grid.” Once in the grid, the power is fungible and correlation of power and the source (solar, wind, coal, etc.) is lost. For renewable energy generators, renewable energy credits (known as “RECs”) are produced when power if delivered to the grid. Those RECs can then be re-associated with power consumed from the grid, so that the power consumed can be correlated with generation from a renewable source. By law, a user of energy from the grid cannot claim to be using renewable energy unless the user has acquired RECs commensurate with the renewable energy usage claimed.

Utility-scale installations can help reduce the capital cost per output kW of any renewable energy system, but such systems are grid-tied and provide no means for feeding distinctly identifiable renewable energy to specific consumption points. However, many people are interested in doing their part to participate in and use renewable energy resources. It is difficult to connect such individuals with renewable energy resources since the scale of production far exceeds an individual's scale of consumption. Previously, only large companies had the facility-wide loads sufficiently large to justify purchase of renewable energy credits in the large increments available, for matching at the point of consumption. Alternatively, consumption from large groups of people needed to be aggregated, for example the customers of a utility company, before any correspondence was established with renewable energy production. There is a need to allow individuals to match their energy consumption with renewable energy resources without requiring aggregation of large groups. Previously, it has not been possible for small scale energy use to be correlated with RECs, despite the widespread demand for renewable energy in powering devices such as personal electronics and common appliances. Accordingly, there is a need for apparatuses that facilitate renewable energy consumption at the point of use, and that are suitable for use with small scale power consuming device.

Electrically powered vehicles are becoming popular, in part due to individuals' desire to be more “green” in the transportation. However, charging an electrical vehicle from a grid-connected charging station could mean that the electric vehicle is being charged with electricity generated from a coal-fired generation plant. This is not consistent with the desire of the vehicle owner.

Charging stations have been proposed that draw their power directly from an on-site renewable energy generation system, such as photovoltaic panels. This direct renewable generation poses many challenges, since it is only operable when the sun is shining, and the peak and continuous power output of the photovoltaic panels might not be matched to the intermittent demands of charging individual vehicles. This is in contrast to the generally steady supply possible with grid-connected stations, where the grid can average out instantaneous demand across very large numbers of users. Accordingly, there is a need for methods and apparatuses that allow the benefits of grid-connected power while still allowing individuals to charge electrical vehicles with confidence that the power is from a renewable energy source.

### DESCRIPTION OF INVENTION

The present invention provides methods and apparatuses that can establish a correspondence between individual energy consumption and renewable energy resources. The invention can described as comprising two elements combined into an independently verifiable system: (1) a suitably accurate means of tracking or otherwise determining the power consumption of a device or devices of interest; and (2) a third-party auditable, renewable energy credit tracking system that matches (whole or fractional) renewable energy credits to the power consumed by the device or devices. The inventions are described herein in the context of various example embodiments. Those skilled in the art appreciate that the various aspects and components described can be combined in various ways, and that variations can be accommodated, without departing from the present invention.

### BRIEF DESCRIPTION OF THE DRAWINGS

FIG. 1 is a schematic illustration of an example embodiment of the present invention.

FIG. 2 is a schematic illustration of another example embodiment of the present invention.

FIG. 3 is a schematic illustration of another example embodiment of the present invention.

FIG. 4 is a schematic illustration of another example embodiment of the present invention.

FIG. 5 is a schematic illustration of another example embodiment of the present invention.

FIG. 6 is a schematic illustration of one aspect of the present invention.

### MODES FOR CARRYING OUT THE INVENTION AND INDUSTRIAL APPLICABILITY

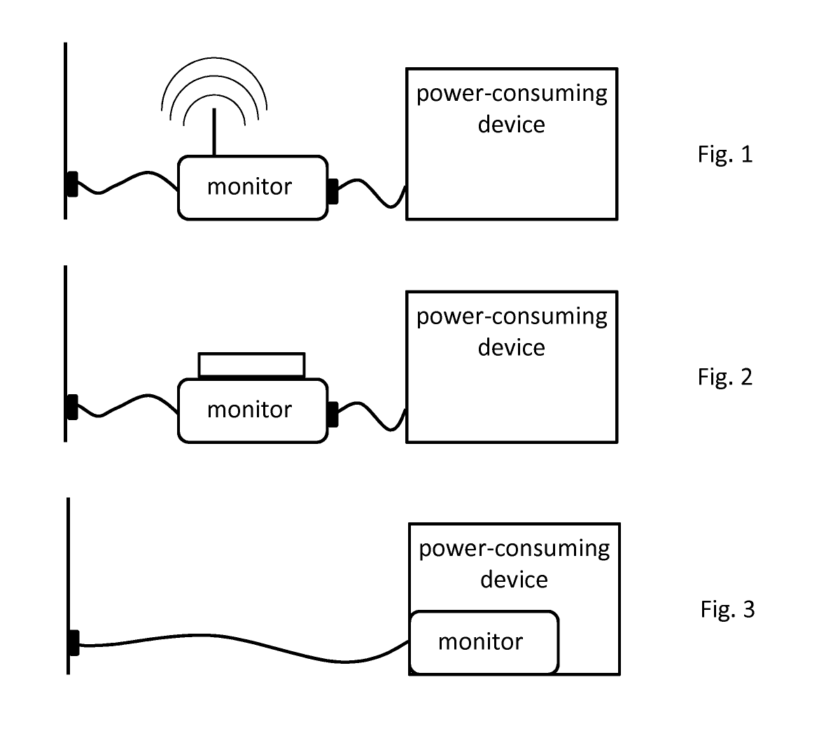

FIG. 1 is a schematic illustration of an example embodiment of the present invention. A power-consuming device is connected to a conventional power source via a monitor. The power consuming device can be any device that consumes power such as computers, lights, appliances, entertainment devices, etc. The conventional power source can be a connection that is commonly used with the power consuming device, for example a conventional wall outlet in a dwelling. The monitor can be configured like a common power strip, where the monitor plugs into a wall outlet and provides an outlet for the device. It can also be hard-wired into the dwelling or into the device. It can also comprise a device that monitors power without requiring mechanical connection, for example a clamp-on ammeter.

The monitor can track the power consumed by the device. As examples, the monitor can track the power actually delivered to the device; the monitor can track the time that power is delivered to the device and infer total power from the time combined with an average power consumption; the monitor can track current delivered to the device and infer total power from the current delivered and knowledge of the usual line voltage. Other measures of total power, or surrogate measures related to total power, can also be used.

The monitor can be configured to communicate with a network such as the internet, directly or through another device such as by a local area network to a computer that then communicates to the internet. The power consumption as determined by the monitor can be correlated with a user account maintained on a remote computer system. The individual desiring to correlate personal power consumption can establish an account that correlates this monitor with renewable energy credits. As an example, an individual can purchase renewable energy credits and maintain a balance in an on-line account. The monitor can then draw down the account balance as the monitor determines power is consumed. The user can be reminded when the account balance drops below a threshold, or the account can be automatically renewed by pre-established purchase authorization, or a subscription model, or other on-line commerce structures. The accounts can be maintained and funded by individual users for their own use, as gifts to others, or by groups of individual users (e.g., co-ops or families), as examples. A plurality of monitors can communicate with a single local computer, which then communicates with an internet-accessible account management facility.

FIG. 2 is a schematic illustration of another example embodiment of the present invention. The device, monitor, and power source can be as described above. The monitor in this example, however, is not connected to a network. Rather, the monitor has a subsystem that validates renewable energy credits at the monitor. For example, the monitor can comprise a magnetic card reader. The individual can purchase credits at another location such as a kiosk, and “load” those credits on a card, or the credits can be preloaded on a card. The user can then transfer the credits from the card to the monitor, and the monitor can track the power consumption relative to the credits transferred to the monitor. When the balance is below a threshold, the monitor can notify the user, for example by an audibly tone or a visible alert such as a light. Mechanisms other than card readers can be used for similar results; e.g., a keypad can allow input of passcodes that are purchased in connection with credits, and usable a limited number of times (e.g., single use) with a monitor. The monitor can also have a connection suitable for use with a separate communications-capable device such as a mobile phone. The separate device can communicate with remote systems and purchase credits, and then communicate with the monitor (e.g., by a mini-USB cable or Bluetooth or near-field communications, as examples) to add credits to the monitor's internal tracking, or to access the power consumption determined by the monitor and update a balance tracking facility on the phone or on a remote system.

A monitor as discussed herein can comprise any of a number of forms. Several examples follow. A monitor can comprise a separate unit, comparable to a power conditioner, and can be integrated into a power conditioner. A monitor can be integrated into an extension cord. A monitor can be comprise a multi-outlet device, comparable to a power strip. A monitor can comprise a unit configured to plug directly into a wall outlet, and to accept a cord plugged into the monitor unit. A monitor can comprise an electrical outlet, configured to be installed in a conventional electrical junction box as a replacement for conventional electrical outlets. A monitor can comprise a unit that mounts with and surrounds an electrical power cord, allowing inductive sensing of the power delivered through the cord. Those skilled in the art will appreciate other monitor configurations suitable for use with the present invention.

A monitor can also incorporate any of various ways to communicate to a user the status of the renewable energy correspondence affected by the monitor. Examples follow. A monitor can present a visible indicator to the user, for example a green light or other indicator when the power consumption has not exceeded the renewable energy credits assigned to the monitor, and red or brown light or indicator when the power consumption has exceeded the credits. A monitor can initiate an electronic message to a user indicating the status, on a regular schedule or based on the correspondence of credits to power consumption (e.g., a notice when the credit balance is less than 10%, and again when it reaches zero). A monitor can alter the power delivered to the device based on credit balance, e.g., the monitor can cause lights connected to the monitor to blink periodically when the credit balance is below a threshold, or can stop the power altogether if the device is only to be powered when credits are available. A monitor can produce an audible signal responsive to the credit balance, e.g., a warning chirp when the balance is less than 10%, or there are less than 24 hours of power remaining, or when the credits have been exhausted.

FIG. 3 is a schematic illustration of another example embodiment of the present invention. A monitor is implemented as part of a power consuming device. As an example, a monitor can be implemented as an electronic circuit that is configured as part of the power input portion of the power-consuming device. As another example, in intelligent devices such as personal computers, notebook computers, smart phones, and tablet computers, software can use native capabilities of the device to implement a monitoring function in software only or in combination with circuitry.

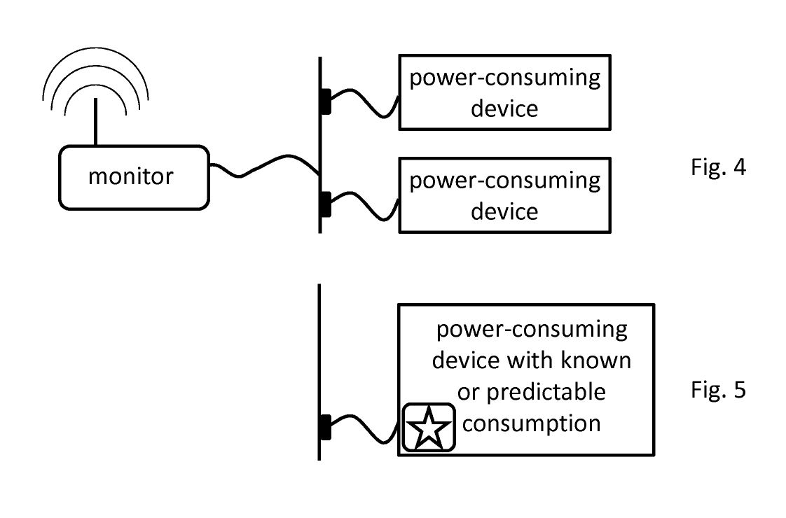

FIG. 4 is a schematic illustration of another example embodiment of the present invention. A monitor, which is illustrated like that in FIG. 1 but can be according to any of the examples, is connected to one side of a power distribution system. As an example, the power distribution system can be a multi-outlet apparatus accommodating plugs from a plurality of devices. As another example, the power distribution system can be a part or all of a home electrical system. A plurality of power consuming devices can be connected to the other side of the power distribution system. A single monitor can thereby aggregate the power consumption of a plurality of devices, allowing a larger scale correspondence of individual power consumption without requiring additional monitors.

FIG. 5 is a schematic illustration of another example embodiment of the present invention. In this example, there is not a need for external communication regarding power consumption of the device. Rather, an identifiable feature is embedded in or mounted with the device. The feature corresponds to renewable energy credits. The feature can be made as part of the device, or can be affixed to it such as by a sticker. The feature can be certified to represent a certain number of renewable energy credits, for example a determined number of kw hrs, or can represent an amount of time related to the energy credits and the expected or average power consumption of the device (e.g., 100 hours of computer usage), or can represent a unit of use of the device that is related to power consumption (e.g., 100 pots of coffee from a coffee maker). A purchaser of the device can then purchase renewable energy credits embedded within the device, that cover some specified portion of the device's expected power consumption, and be assured of the correspondence of those credits to the user's power consumption by the certification associated with the feature. The feature can have an expiration indicator, such as a fixed expiration date (e.g., corresponding to an expected time until the associated credits have been exhausted) or a monitored usage (e.g., a hardware or software measure of usage time such as hours, or a measure of output such as number of pots of coffee produced). The device owner can also be offered a means of purchasing additional increments of credits (e.g., 100 more pots of coffee) once the original embedded credit has expired or been consumed.

The present invention allows the recombination of energy credits with consumption at the actual individual consumption level. As an example, solar energy credits (corresponding to large quantities of solar power) can be separated into units suitable for individual-scale consumption. The use of monitors like those described above, or certifications that can be associated with individual devices, provides an ability for individuals to participate in renewable energy in way not possible before.

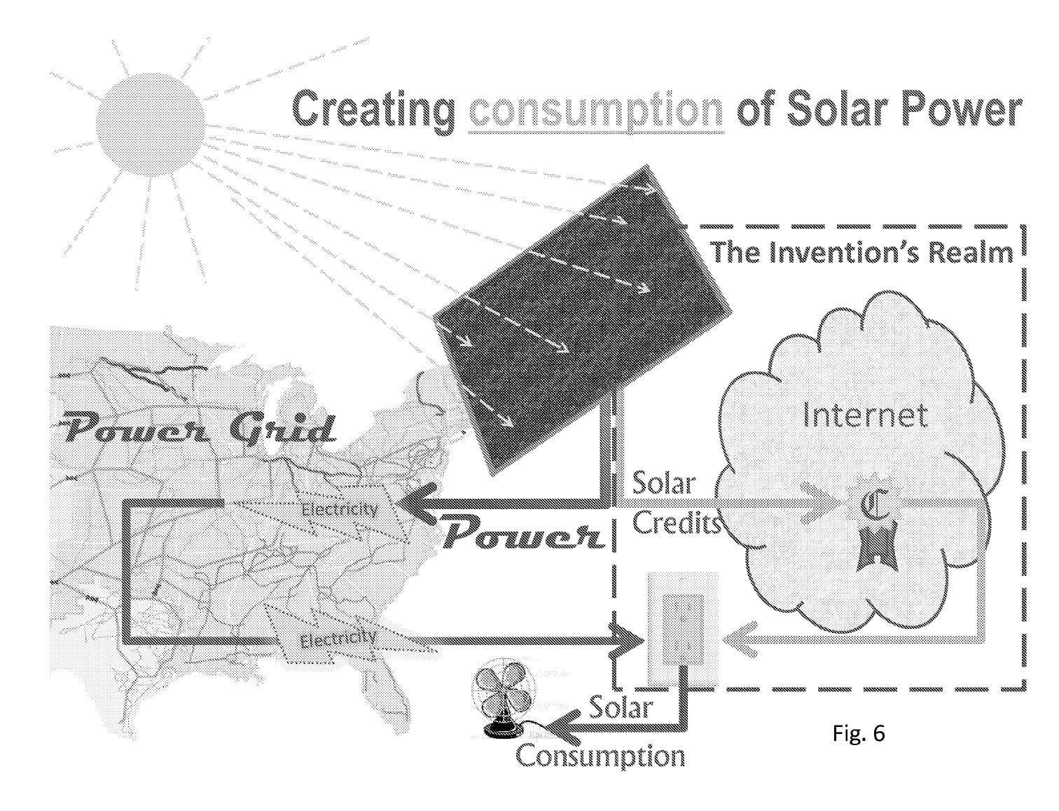

FIG. 6 is a schematic illustration of one aspect of the present invention. Electrical power is generated from a renewable source, in the figure represented by solar cells. Such power generation also yields solar energy credits. The power is supplied to the grid, where it is commingled with power generated from a variety of sources, including conventional non-renewable sources. The solar credits, separated from the power, are managed by an internet system and recombined with power at the point of use, represented in the figure as a power outlet feeding an electric fan.

The present invention provides methods and apparatuses that can establish a correspondence between renewable energy resources and energy consumption in connection with charging electric vehicles.

In an example charging station according to the present invention, a charging station has a connection configured to receive power from the grid. The charging station also has a vehicle charging interface, configured to transmit electrical power to a vehicle to be charged. The charging station also has an association system, where the association system monitors the power delivered to the vehicle and associates that power with renewable energy credits, such that the individual charging the vehicle can be assured that the vehicle is being charged with electrical energy generated from renewable energy sources.

The grid connection of the station can comprise any of a number of electrical connection means known in the art. The present invention can accommodate grid connections now known or developed in the future. The vehicle charging interface can comprise any configuration that accommodates delivery of electrical energy to a vehicle to be charged. As an example, a wire with a connector termination configured to mate with input connectors on vehicles can be suitable. As another example, an inductive charging interface can allow vehicle charging without requiring physical contact with a wire. The present invention can accommodate vehicle charging interfaces now known or developed in the future.

The association system can comprise various implementations, depending on the desired characteristics of the overall system. Several examples are described below.

In an example embodiment, the association system can comprise a data processing system (DPS). The DPS accepts signals from the vehicle interface indicative of the amount of energy delivered to the vehicle. The DPS then converts, as needed, the energy quantity delivered to units compatible with RECs, and subtracts RECs (whole or fractional) corresponding to the energy delivered from a balance of RECs maintained by the DPS. The balance of RECs can be increased by human operator input, and can be increased by automated operation of the DPS. For example, the DPS can communicate with a remote source of RECs (e.g., owned by the owner of the station, or an electronic commerce system that accommodates automated purchases of RECs) to acquire additional RECs as needed. The DPS can acquire additional RECs when the balance drops below a threshold, or when usage indicates that the balance is likely to soon drop below a threshold, or when a vehicle charging event indicates that more, or a particular type, of REC is desired. The DPS can also communicate to a user, such as the operator of the vehicle being charged, a confirmation that the energy was associated with a renewable source. The DPS can further communicate information concerning the renewable source, such as the type (e.g., solar or wind) and the location (e.g., to accommodate requests for locally-generated renewable energy).

In an example embodiment, the association system can comprise a communication facility that communicates with a source of RECs associated with the vehicle. As examples, the vehicle itself can have an identity that is associated with RECs; the vehicle operator can have an identifier such as a key fob, magnetic stripe card, near field communications device, or other identifier that allows this charging event to be associated with a source of RECs. If the vehicle is associated with RECs, the vehicle can provide onboard maintenance of a balance of RECs, which balance can be maintained an updated as discussed with a REC balance maintained by the station. The vehicle can also be associated by its manufacturer with a source of RECs; e.g., a vehicle manufacturer or dealer can acquire sufficient RECs to match charging of its vehicles, allowing the manufacturer or dealer to sell vehicles that are not only electric but also tied to renewable energy sources.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

1. An apparatus for delivering renewable energy, comprising:
(a) an input port configured to accept power from an electrical grid;
(b) an output port configured to deliver power to an electrical load;
(c) a correlation system configured to determine power delivered to the load and to correlate delivered power with renewable energy credits.

2-3. (canceled)

4. An apparatus as in claim 1, wherein the correlation system is configured to deduct delivered power from a balance of renewable energy credits associated with the apparatus.

5. An apparatus as in claim 4, wherein the correlation system is configured to accept an input signal indicating an increase in the balance of renewable energy credits associated with the apparatus.

6. An apparatus as in claim 1, wherein the correlation system comprises a data processing system mounted remote from the input port, and wherein the meter is configured to communicate delivered power to the data processing system, and wherein the data processing system is configured to deduct power consumption from a balance of renewable energy credits associated with the meter or with the data processing system.

7. An apparatus as in claim 1, wherein the output port is configured to accept an identification of the load receiving power from the output port, and wherein the correlation system is configured to deduct delivered power from a balance of renewable energy credits associated with the identified load.

8. An apparatus as in claim 1, further comprising a communication system configured to communicate to a user an indication responsive to the renewable energy credits consumed by the load.

9. An apparatus as in claim 8, wherein the communication system comprises a visible indicator that changes appearance when the correlation system indicates that the delivered power has exceeded a balance of renewable energy credits associated with the apparatus or with the load.

10. An apparatus as in claim 8, wherein the communication system comprises a visible indicator whose appearance is indicative of a balance of renewable energy credits associated with the apparatus or with the load.

11. An apparatus as in claim 8, wherein the communication system comprises a visible indicator whose appearance is indicative of the rate of change of renewable energy credits associated with the apparatus or with the load.

12. An apparatus as in claim 8, wherein the communication system comprises a wireless communication facility configured to communicate with a communication network.

13. An apparatus as in claim 8, wherein the communication system is configured to communicate with an application running on a smartphone.

14. An apparatus as in claim 1, further comprising a communication system configured to communicate with a computer network.

15. An apparatus as in claim 14, wherein the communication system is configured to communicate with the computer network a balance of renewable energy credits associated with the apparatus or with the load.

16. An apparatus as in claim 15, wherein the communication system is configured to initiate acquisition of renewable energy credits when the balance of renewable energy credits is below a threshold quantity.

17. An apparatus as in claim 1, wherein the correlation system is configured to maintain a balance of renewable energy credits, and to decrease the balance responsive to delivered power, and to increase the balance responsive to an input signal, and to control an indicator whose state is indicative of the balance.

18-19. (canceled)

20. An apparatus as in claim 17, wherein the correlation system is configured to accept a signal indicating a source of renewable energy credits, and the indicator indicates a source of renewable energy credits

21. An electric vehicle charging station, comprising:
(a) a grid connection configured to accept electrical energy from an electrical grid;
(b) a vehicle interface configured to deliver electrical energy to a vehicle to be charged;
(c) an association system configured to monitor energy delivered to the vehicle, and associate that energy with renewable energy credits (RECs).

22. An apparatus as in claim 21, wherein the association system comprises a data processing system that maintains a balance of RECs, and deducts from the balance responsive to energy delivered to a vehicle.

23. An apparatus as in claim 22, wherein the data processing system adds to the balance responsive to one or more of: an operator input, a request generated by the data processing system to an external source of RECs.

24. An apparatus as in claim 21, wherein the association system comprises a communication facility that communicates with a REC accounting system presented to the station in connection with a vehicle charging event, and wherein the association system communicates to the REC accounting system the energy delivered to the vehicle during the vehicle charging event.

25. An apparatus as in claim 21, wherein the association system accepts an identifier presented to the station in connection with a vehicle charging event, and wherein the association system communicates with a REC accounting system the identifier and the energy delivered to the vehicle during the vehicle charging event.

26. An apparatus as in claim 21, wherein the association system accepts an input associated with a vehicle charging event, which input indicates a desired renewable energy source, and wherein the association system associates energy delivered to the vehicle with RECs corresponding to the desired renewable energy source.

27. An apparatus as in claim 21, wherein the association system communicates to a user the availability of RECs to associate with charging the user's vehicle, and accepts an input from the user providing payment for RECs associated with charging the user's vehicle.

28. An apparatus as in claim 27, wherein the payment required is determined responsive to input from the user indicative of a type or source of renewable energy desired.

29. An apparatus as in claim 21, wherein the association system communicates to the user one or more of: a balance of RECs available before charging, a balance of RECs available after charging, a balance of RECs available at multiple times during charging, a balance of RECs consumed after charging, a balance of RECs consumed at multiple times during charging, a renewable energy generation type associated with the RECs, a renewable energy facility associated with the RECs, a sponsor providing the RECs.

30-38. (canceled)
